(19) United States
(12) Patent Application Publication
(10) Pub. No.: US 2007/0138757 A1
(43) Pub. Date: Jun. 21, 2007

(54) Modular composite base running board

(76) Inventors: Christopher J. Kuntze, Clarkston, MI (US); Dan Glovak, Troy, MI (US)

Correspondence Address: CLARK HILL, P.C., 500 WOODWARD AVENUE, SUITE 3500, DETROIT, MI, 48226, US

(21) Appl. No.: 11/638,611

(22) Filed: Dec. 13, 2006

Related U.S. Application Data
(60) Provisional application No. 60/750,717, filed on Dec. 15, 2005.

(51) Int. Cl. B60R 3/00

(52) U.S. Cl. 280/163

(57) ABSTRACT

A running board is provided for a motor vehicle. The running board includes a stepping platform having a step side and an underside each extending longitudinally between opposing end walls and laterally between an inboard wall and an outboard wall. A bracket integrally molded with the stepping platform is adapted to be secured to the vehicle. A plurality of primary reinforcing ribs extends along the underside of the stepping platform between the inboard wall and the outboard wall. A plurality of secondary reinforcing ribs extends along the underside of the stepping platform. At least one of the plurality of secondary reinforcing ribs abut at least one of the inboard and outboard walls. The plurality of primary and secondary reinforcing ribs provide support to the running board as a downward force is applied to the step side of the stepping platform.

### CROSS-REFERENCE TO RELATED APPLICATION

This application claims priority to and all the benefits of U.S. provisional patent application Ser. No. 60/750,717, filed on Dec. 15, 2005 and entitled “Modular Composite Base Running Board.”

### BACKGROUND OF THE INVENTION

1. Field of the Invention

The invention relates to a running board for attachment to a motor vehicle. More particularly, this invention relates to a running board including a stepping platform having integrally molded primary and secondary reinforcing ribs for supporting loads placed thereon.

2. Description of Related Art

Running boards for motor vehicles, particularly pick-up trucks and sport utility vehicles, have become a popular optional body feature. Early running boards, including as its main components a stepping platform and a mounting bracket, were made exclusively of metal. Later, with the advent of composite materials, manufacture of plastic stepping platforms became common. These running boards with plastic stepping platforms were cost-effective and lighter when compared to their metal counterparts.

Despite changes in the types of materials used, running boards are still assemblies of more than one part. Typically, these parts include a stepping platform or deck, and a mounting bracket for attaching the platform or deck to the motor vehicle. Various ones of such assemblies are disclosed in U.S. Pat. No. 4,311,320 to Waters; U.S. Pat. No. 4,557,494 to Elwell; U.S. Pat. No. 5,193,829 to Holloway et al.; U.S. Pat. No. 5,286,049 to Khan; U.S. Pat. No. 5,382,035 to Waddington et al; U.S. Pat. No. 5,511,750 to Evenson; and U.S. Pat. No. 5,713,589 to Delgado et al. Since the platform of the running board is cantilevered outwardly from the motor vehicle, a moment of force is created which results in high stresses at the point about which the cantilevered platform is urged to rotate by loads thereon. It is, therefore, difficult to provide a structure wherein the platform and the mounting bracket can be made of an integrally molded material with the bracket having the requisite strength for resisting the loads on the platform.

Therefore, there is a continuous need to provide a one-piece, integrally molded running board which is easily installed, lightweight, and economically manufactured yet retains the requisite strength for supporting an individual while entering or exiting the motor vehicle.

### SUMMARY OF THE INVENTION

According to one aspect of the invention, a running board is provided for a motor vehicle. The running board includes a stepping platform having a step side and an underside each extending longitudinally between opposing end walls and laterally between an inboard wall and an outboard wall. At least one bracket is integrally molded with the stepping platform and is adapted to be secured to the motor vehicle. A plurality of primary reinforcing ribs extends along the underside of the stepping platform. Each of the plurality of primary reinforcing ribs extend between the inboard wall and the outboard wall. A plurality of secondary reinforcing ribs extends along the underside of the stepping platform. At least one of the plurality of secondary reinforcing ribs abut at least one of the inboard and outboard walls. The plurality of primary and secondary reinforcing ribs provide support to the running board as a downward force is applied to the step side of the stepping platform

### BRIEF DESCRIPTION OF THE DRAWINGS

The present invention will be readily appreciated as the same becomes better understood by reference to the following detailed description when considered in connection with the accompanying drawings wherein:

FIG. 1 is a perspective view of a motor vehicle incorporating a running board according to the invention;

FIG. 2 is an exploded perspective view of the running board;

FIG. 3 is a bottom view of the running board;

FIG. 4 is a cross-sectional view taken along lines 4-4 of FIG. 1;

FIG. 5 is an enlarged bottom view of an end bracket for attaching the running board to the vehicle; and

FIG. 6 is an enlarged bottom view of a main bracket for attaching the running board to the vehicle.

### DETAILED DESCRIPTION OF THE PREFERRED EMBODIMENT

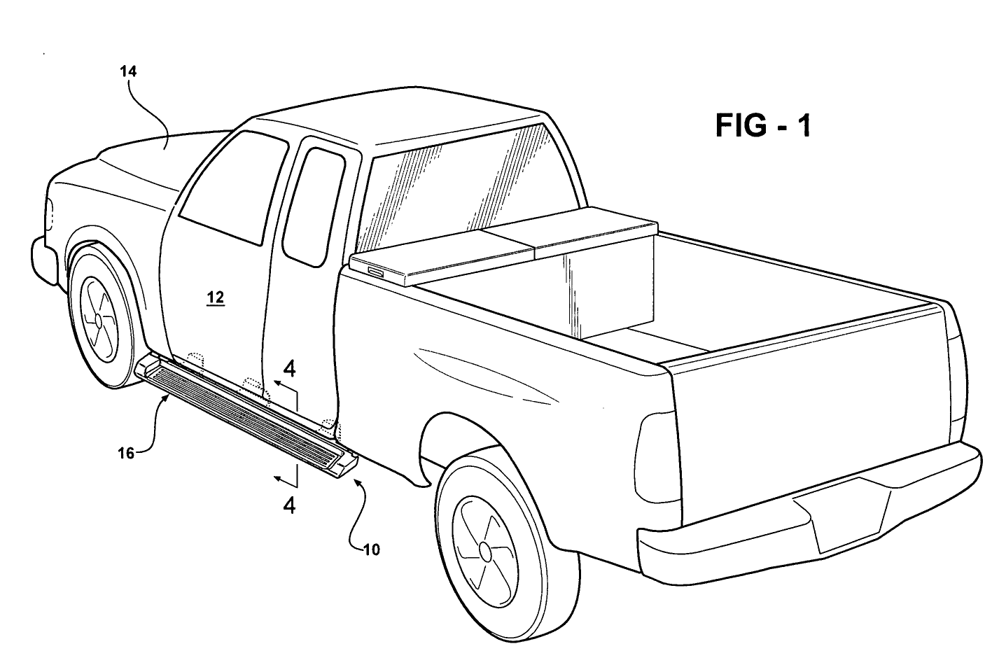

Referring to FIG. 1, a running board, generally shown at 10, is adapted for attachment to a side 12 of a motor vehicle 14. The running board 10 includes a stepping platform, generally indicated at 16, for supporting an individual entering or exiting the motor vehicle 14.

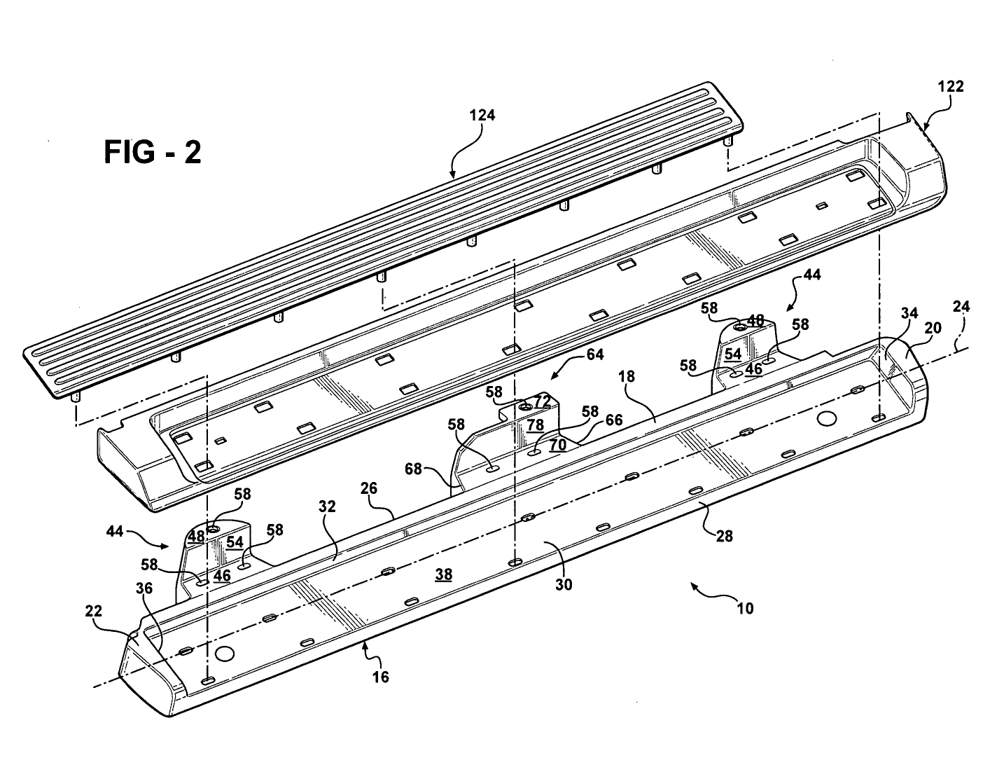

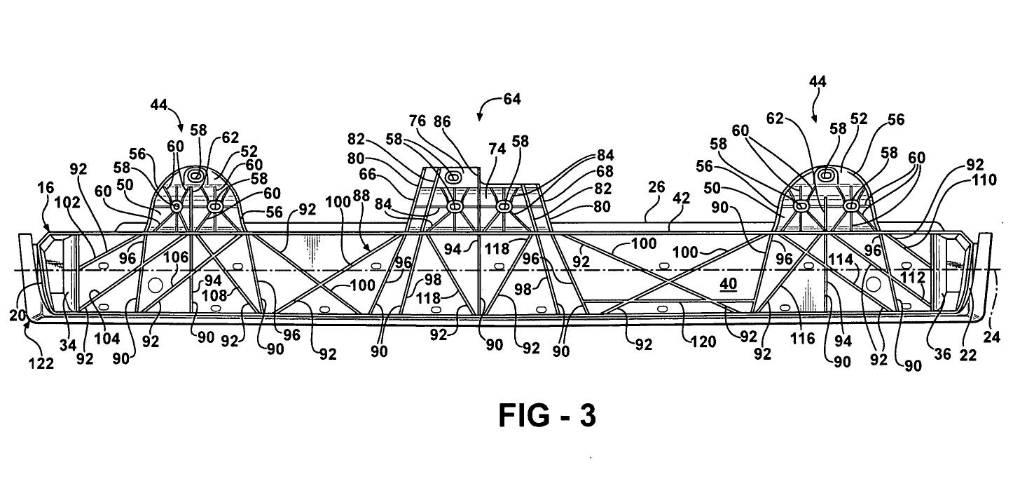

Referring to FIGS. 2 and 3, the stepping platform 16 extends between a first end 20 and a second end 22 along a longitudinal axis 24. The stepping platform 16 also extends laterally between an inboard edge 26 and an outboard wall 28. The stepping platform 16 includes a raised portion 18 extending longitudinally between the first 20 and second 22 ends and laterally between the inboard edge 26 and the outboard wall 28.

A recessed step 30 is formed in the raised portion 18 and is defined by a toe wall 32 extending between opposing vertical end walls 34, 36. The recessed step 30 extends laterally between the toe wall 32 and the outboard wall 28. The recessed step 30 includes a step side 38 and an underside 40. The end walls 34, 36 extend upward to the raised portion 18 and downward below the underside 40 of the recessed step 30, as shown in FIG. 3.

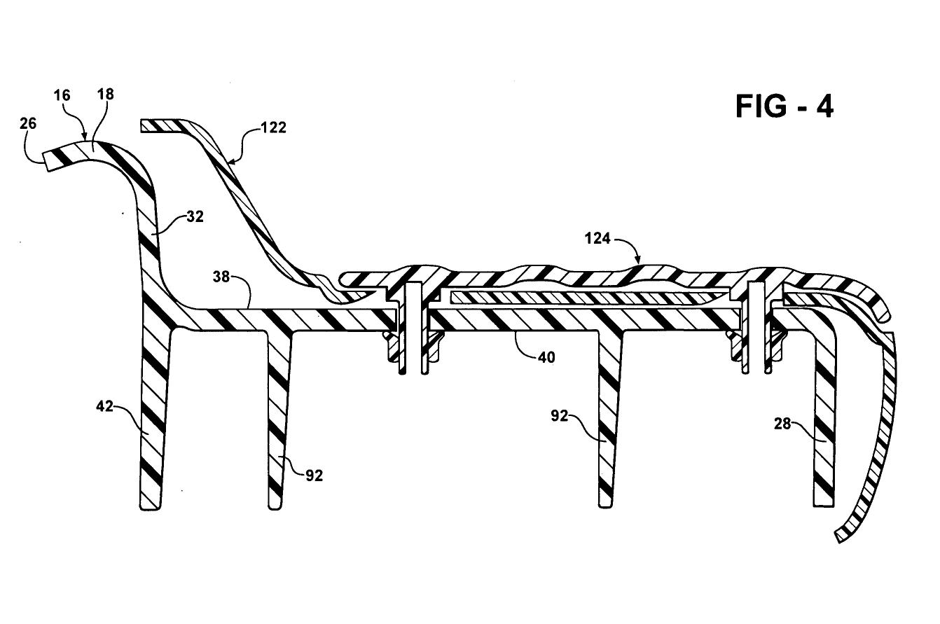

An inboard wall 42 is aligned with the toe wall 32 and extends downward below the underside 40 of the recessed step 30, as shown in FIG. 4. The inboard wall 42 extends longitudinally between the first 20 and second 22 ends of the stepping platform 16.

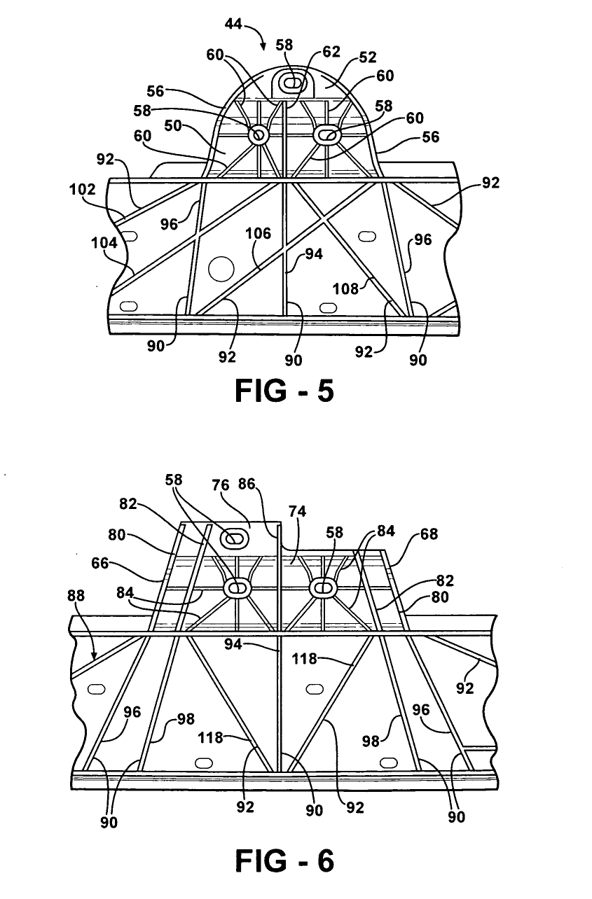

Referring to FIGS. 2, 3, and 5, a pair of end brackets, generally shown at 44, is integrally molded with the stepping platform 16 and extends laterally from the inboard wall 42 thereof. Each end bracket 44 includes a lower mounting portion 46 and an upper mounting portion 48. The lower 46 and upper 48 mounting portions each include respective bottom surfaces 50, 52. The lower mounting portion 46 extends laterally from the raised portion 18 of the stepping platform 16 to an upright surface 54. The upright surface 54 extends upwardly to the upper mounting portion 48. In addition, each end bracket 44 includes at least one peripheral wall 56 extending out from the inboard wall 42 about a majority of the periphery of the end bracket 44 and below the bottom surfaces 50, 52. Preferably, the at least one peripheral wall 56 is generally arcuate. Each of the lower 46 and upper 48 mounting portions also includes at least one mounting aperture 58 extending therethrough for receiving a bolt or similar fastener to attach the running board 10 to the motor vehicle 14.

A plurality of end bracket ribs 60 extends from the bottom surface 50 of each lower mounting portion 46 to provide additional support thereto. The plurality of end bracket ribs 60 extends radially outward from each mounting aperture 58 formed in each lower mounting portion 46. Although there are eight end bracket ribs 60 shown in FIG. 3, it is appreciated that any number of end bracket ribs 60 may be formed in association with the bottom surface 50 of the lower mounting portion 46. An end bracket reinforcing rib 62 is disposed between the peripheral walls 56 and extends along the bottom surface 50 of the lower mounting portion 46 in a plane transverse to the longitudinal axis 24 of the stepping platform 16.

Referring to FIGS. 2, 3, and 6, a main bracket, generally shown at 64, is disposed between the end brackets 44 and is integrally molded with the stepping platform 16. The main bracket 64 extends laterally from the inboard wall 42 and extends therealong between a forward edge 66 and a rearward edge 68. The main bracket 64 includes a lower mounting portion 70 and an upper mounting portion 72 each having a respective bottom surface 74, 76. The lower mounting portion 70 extends laterally from the raised portion 18 of the stepping platform 16 to an upright surface 78. The upright surface 78 extends upwardly to the upper mounting portion 72. In addition, the main bracket 64 includes outer walls 80 extending from the inboard wall 42 along the forward 66 and rearward 68 edges and below the bottom surfaces 74, 76. Inner walls 82 are parallel to and disposed inward of the outer walls 80. Each of the lower 70 and upper 72 mounting portions includes mounting apertures 58 extending therethrough for receiving a bolt or similar fastener to attach the running board 10 to the motor vehicle 14.

A plurality of main bracket ribs 84 extends from the bottom surface 74 of the lower mounting portion 70 to provide additional support thereto. The plurality of main bracket ribs 84 extends radially outward from each mounting aperture 58 of the lower mounting portion 70. Although there are eight main bracket ribs 84 shown in FIG. 3, it is appreciated that any number of main bracket ribs 84 may be formed in association with the bottom surface 74 of the lower mounting portion 70. A main bracket reinforcing rib 86 is disposed between the inner walls 82 and extends along the bottom surfaces 74, 76 of the lower 70 and upper 72 mounting portions in a plane transverse to the longitudinal axis 24 of the stepping platform 16.

Although the Figures show two end brackets 44 and one main bracket 64, it is contemplated that the number of brackets 44, 64 utilized for supporting the running board 10 may vary. It is preferred that the main bracket 64 be positioned directly below the area along the stepping platform 16 where the individual is most likely to step while entering or exiting the motor vehicle 14. FIGS. 1 through 3 also depict the main bracket 64 as being larger and generally a different shape than the end brackets 44. The size and shape of the end brackets 44 and the main bracket 64 may, however, vary.

Further, the end brackets 44 and the main bracket 64 are not equally spaced apart from one another along the stepping platform 16. It is, however, contemplated that the end 44 and main 64 brackets may be positioned along the stepping platform 16 in any of a multitude of configurations. For example, the end 44 and main 64 brackets may be equally spaced apart from one another longitudinally along the stepping platform 16.

Referring now to FIG. 3, a plurality of reinforcing ribs, generally indicated at 88, extends along the underside 40 of the recessed step 30. More particularly, the plurality of reinforcing ribs 88 includes a plurality of primary 90 and secondary 92 reinforcing ribs. The layout of the plurality of reinforcing ribs 88 is designed to provide support for the stepping platform 16 and transfer a load applied upon the step side 38 to the end 44 and main 64 brackets, and then to the motor vehicle 14.

The plurality of primary reinforcing ribs 90 extends along the underside 40 of the recessed step 30 from the inboard wall 42 to the outboard wall 28. The plurality of primary reinforcing ribs 90 includes central ribs 94 aligned with each end bracket reinforcing rib 62 and main bracket reinforcing rib 86. The plurality of primary reinforcing ribs 90 also includes outer ribs 96 aligned with the peripheral walls 56 of the end brackets 44 and the outer walls 80 of the main bracket 64. The plurality of primary reinforcing ribs 90 further includes inner ribs 98 aligned with the inner walls 82 of the main bracket 64.

The plurality of secondary reinforcing ribs 92 extends along the underside 40 of the recessed step 30, obliquely to the longitudinal axis 24, from the inboard wall 42 to either the outboard wall 28 or one of the end walls 34,36. The plurality of secondary reinforcing ribs 92 includes crossing ribs 100 disposed in an X configuration between two of the outer ribs 96. Each crossing rib 100 extends obliquely between the inboard wall 42 and the outboard wall 28. The plurality of secondary reinforcing ribs 92 also include forward ribs 102, 104, 106, 108 and rearward ribs 110, 112, 114, 116. A portion of the forward 102, 104 and rearward 110, 112 ribs extends obliquely between the inboard wall 42 and one of the end walls 34, 36, respectively. The remaining forward 106, 108 and rearward 114, 116 ribs extend obliquely between the inboard wall 42 and the outboard wall 28. The plurality of secondary reinforcing ribs 92 further includes middle ribs 118 each extending obliquely between the inboard wall 42 and the outboard wall 28 in the space between one of the inner ribs 98 and the central rib 94 of the main bracket 64.

A longitudinal rib 120 is parallel to and spaced apart from the outboard wall 28 and extends along the underside 40 of the recessed step 30 to provide additional support to the stepping platform 16. The longitudinal rib 120 extends between two outer ribs 96 and intersects at least one of the crossing ribs 100. It is contemplated that the longitudinal rib 120 may extend along a portion or the entire length of the underside 40 of the recessed step 30 and intersect one or more of the plurality of primary 90 and secondary 92 reinforcing ribs without varying from the scope of the invention.

As a downward force is applied to the stepping platform 16, a load is borne by the plurality of primary reinforcing ribs 90 and the plurality of secondary reinforcing ribs 92. The plurality of primary 90 and secondary 92 reinforcing ribs transfers the load to the end 44 and main 64 brackets until finally, the load is transferred to the motor vehicle 14 itself. This load transfer allows an initial downward force to be taken off of the stepping platform 16 and shifted to the motor vehicle 14, thus allowing the running board 10 to withstand the downward force.

The running board 10 is manufactured so that the end 44 and main 64 brackets are integrally molded with the stepping platform 16. In addition, the plurality of bracket ribs 60, 84 are integrally molded with the end 44 and main 64 brackets, and the plurality of reinforcing ribs 88 are integrally molded with the stepping platform 16. Thus, the running board 10 is an integral, homogeneous, or one-piece member molded of organic, polymeric, or plastic material. The chosen material may be reinforced with long glass fibers, utilizing methods disclosed in co-owned U.S. Pat. No. 6,951,357, which is hereby incorporated by reference.

The running board 10 may also include a cover, generally indicated at 122, which is removably coupled to the stepping platform 16 to alter the cosmetic appearance of the running board 10. Additionally, a traction piece, generally indicated at 124, may be removably coupled to either the cover 122 or directly to the stepping platform 16 to provide improved traction for the individual entering or exiting the motor vehicle 14.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A running board for a motor vehicle, said running board comprising:
a stepping platform having a step side and an underside each extending longitudinally between opposing end walls and laterally between an inboard wall and an outboard wall;
at least one bracket integrally molded with said stepping platform and adapted to be secured to the motor vehicle;
a plurality of primary reinforcing ribs extending along said underside of said stepping platform, each of said plurality of primary reinforcing ribs extending between said inboard wall and said outboard wall; and
a plurality of secondary reinforcing ribs extending along said underside of said stepping platform, at least one of said plurality of secondary reinforcing ribs abutting at least one of said inboard and outboard walls;
said plurality of primary and secondary reinforcing ribs providing support to said running board as a downward force is applied to said step side of said stepping platform.

2. A running board as set forth in claim 1 wherein said at least one bracket includes a lower mounting portion and an upper mounting portion each having a bottom surface.

3. A running board as set forth in claim 2 wherein said at least one bracket includes a plurality of bracket ribs integrally molded with and extending along said bottom surface of said lower mounting portion.

4. A running board as set forth in claim 1 wherein said at least one bracket includes a pair of spaced apart end brackets extending out laterally from said inboard wall of said stepping platform.

5. A running board as set forth in claim 4 wherein at least one of said end brackets includes peripheral walls extending from said inboard wall about a periphery of said end bracket.

6. A running board as set forth in claim 5 wherein at least one of said end brackets includes an end bracket reinforcing rib disposed between said peripheral walls and extending transversely to said underside of said stepping platform.

7. A running board as set forth in claim 6 wherein said plurality of primary reinforcing ribs includes a central rib aligned with said end bracket reinforcing rib.

8. A running board as set forth in claim 7 wherein said plurality of primary reinforcing ribs includes a pair of outer ribs aligned with said peripheral walls of said end brackets.

9. A running board as set forth in claim 4 wherein said at least one bracket includes a main bracket disposed between said pair of spaced apart end brackets and extending out laterally from said inboard wall of said stepping platform.

10. A running board as set forth in claim 9 wherein said main bracket extends longitudinally along said inboard wall between a forward edge and a rearward edge.

11. A running board as set forth in claim 10 wherein said main bracket includes outer walls extending from said inboard wall along said forward and rearward edges.

12. A running board as set forth in claim 11 wherein said main bracket includes inner walls parallel to and disposed inward of said outer walls.

13. A running board as set forth in claim 12 wherein said main bracket includes a main bracket reinforcing rib disposed between said inner walls extending transversely to said underside of said stepping platform.

14. A running board as set forth in claim 13 wherein said plurality of primary reinforcing ribs includes a central rib aligned with said main bracket reinforcing rib.

15. A running board as set forth in claim 14 wherein said plurality of primary reinforcing ribs includes a pair of outer ribs aligned with said outer walls of said main bracket.

16. A running board as set forth in claim 15 wherein said plurality of primary reinforcing ribs include a pair of inner ribs aligned with said inner walls of said main bracket.

17. A running board as set forth in claim 16 wherein said plurality of secondary reinforcing ribs includes middle ribs disposed between one of said inner ribs and said central rib of said main bracket and extending obliquely between said inboard and outboard walls.

18. A running board as set forth in claim 9 wherein said plurality of secondary reinforcing ribs includes crossing ribs intersecting one another between said main bracket and one of said end brackets.

19. A running board as set forth in claim 1 including a longitudinal rib disposed between and parallel to said inboard and outboard walls.

20. A running board as set forth in claim 19 wherein said longitudinal rib intersects at least one of said plurality of primary reinforcing ribs.

21. A running board as set forth in claim 19 wherein said longitudinal rib intersects at least one of said plurality of secondary reinforcing ribs.

22. A running board as set forth in claim 19 wherein said longitudinal rib intersects at least one of said plurality of primary reinforcing ribs and at least one of said plurality of secondary reinforcing ribs.

23. A running board as set forth in claim 1 wherein said plurality of secondary reinforcing ribs includes forward and rearward ribs extending obliquely between said inboard wall and one of said end walls.

24. A running board as set forth in claim 1 wherein said plurality of secondary reinforcing ribs includes forward and rearward ribs extending obliquely between said inboard wall and said outboard wall.

25. A running board for a motor vehicle, said running board comprising:
a stepping platform having a step side and an underside each extending longitudinally between opposing end walls and laterally between an inboard wall and an outboard wall;
a pair of spaced apart end brackets extending out from said inboard wall, each of said end brackets having a peripheral wall and lower and upper mounting portions having a bottom surface, said bottom surface of said lower mounting portion including a plurality of bracket ribs extending radially outward from a mounting aperture and an end bracket reinforcing rib disposed between said peripheral walls extending transversely to said underside of said stepping platform;
a main bracket extending out from said inboard wall and disposed between said pair of spaced apart end brackets, said main bracket including lower and upper mounting portions having a bottom surface, a pair of spaced apart outer walls extending out from said inboard wall, and a pair of spaced apart inner walls parallel to and disposed inward of said pair of outer walls, said bottom surface of said lower mounting portion including a plurality of bracket ribs extending radially outward from a mounting aperture and a main bracket reinforcing rib disposed between said inner walls extending transversely to said underside of said stepping platform;
a plurality of primary reinforcing ribs extending along said underside of said stepping platform, said plurality of primary reinforcing ribs including central ribs aligned with each of said end bracket reinforcing ribs and said main bracket reinforcing rib, outer ribs aligned with each of said peripheral walls of said end brackets and said outer walls of said main bracket, inner ribs aligned with said inner walls of said main bracket, and a middle rib disposed between one of said inner ribs and said central rib of said main bracket and extending obliquely between said inboard and outboard walls; and
a plurality of secondary reinforcing ribs extending along said underside of said stepping platform, said plurality of secondary reinforcing ribs including crossing ribs, forward ribs and rearward ribs, said crossing ribs intersecting one another between said main bracket and one of said end brackets, a portion of said forward and rearward ribs extending obliquely between said inboard wall and one of said end walls, and another portion of said forward and rearward ribs extending obliquely between said inboard wall and said outboard wall;
said plurality of primary and secondary reinforcing ribs providing support to said running board as a downward force is applied to said step side of said stepping platform.
